(19) United States
(12) Patent Application Publication
(10) Pub. No.: US 2014/0032348 A1
(43) Pub. Date: Jan. 30, 2014

(54) DISPLAY SYSTEM FOR PRODUCTS AND/OR SERVICES

(71) Applicants: Carlo Antoine Van Onselen, Pretoria (ZA); Jody Botha, Johannesburg (ZA); Lofty Oelofse, Centurion (ZA)

(72) Inventors: Carlo Antoine Van Onselen, Pretoria (ZA); Jody Botha, Johannesburg (ZA); Lofty Oelofse, Centurion (ZA)

(21) Appl. No.: 13/980,952

(22) PCT Filed: Jan. 19, 2012
(86) PCT No.: PCT/IB12/50260

§ 371 Date: Oct. 16, 2013

(30) Foreign Application Priority Data
Jan. 20, 2011 (ZA) 2011-00516

(51) Int. Cl. G06Q 20/20

(52) U.S. Cl. CPC G06Q 20/20; G06Q 20/209
USPC 705/24; 705/16

(57) ABSTRACT

A display system for products and/or services for rent or sale includes a plurality of display devices for displaying information relating to at least one product and/or service. A communication module for receiving information relating to the at least one product and/or service. A controller for controlling the display of the information on at least one of the plurality of display devices. The system may further include a user interface for receiving a product and/or service selection from a user and an output module to output the user's selection.

### BACKGROUND OF THE INVENTION

The present invention relates to a system for displaying products and/or services.

A need exists for a point of purchase information display system that accurately conveys information at the point of purchase allowing a potential purchaser to make an informed decision.

The present invention seeks to address this.

### SUMMARY OF THE INVENTION

According to an example embodiment of the present invention there is provided a display system for products and/or services for rent or sale, the system including:
a plurality of display devices for displaying information relating to at least one product and/or service;
a communication module for receiving information relating to the at least one product and/or service;
a controller for controlling the display of the information on at least one of the plurality of display devices.

The system may further include:
a user interface for receiving a product and/or service selection from a user; and
an output module to output the user's selection.

The output module may be a printer that prints the user selection, preferably in the form of a barcode, or may be any form of communication to user in the form of digital content whether it is email, SMS or file.

In one example each of the plurality of display devices is associated with a product and/or service for rent or sale so that information pertaining to the associated product and/or service is displayed on the display device.

In another example embodiment, at least one of the display devices is larger than the others and at least one of the other display devices displays to the user that information pertaining to the associated product and/or service displayed on the display device can be viewed on the larger display device on receipt of a user input, wherein the controller, on receipt of the user input, displays the requested information on the larger display device.

The communication module may receive information to be displayed in a layered format wherein one or more of the layers may be updated without affecting the other layers thus enabling some information pertaining to a product and/or service to be changed without altering the remaining information.

### BRIEF DESCRIPTION OF THE DRAWING

FIG. 1 shows an example system according to one example embodiment; and

FIG. 2 shows in schematic format the working modules of the system illustrated in FIG. 1.

### DESCRIPTION OF PREFERRED EMBODIMENTS

The present invention provides a display system for products and/or services for rent or sale.

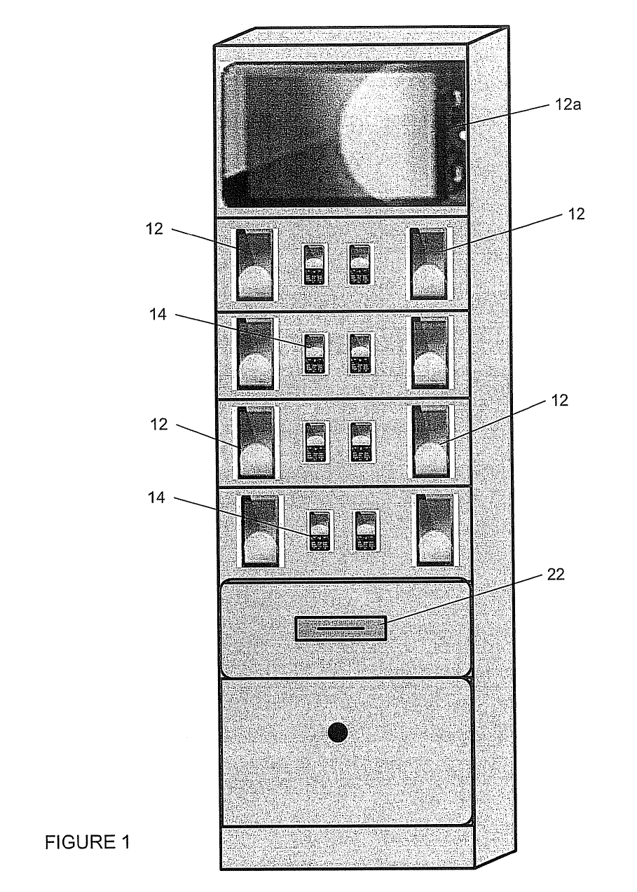

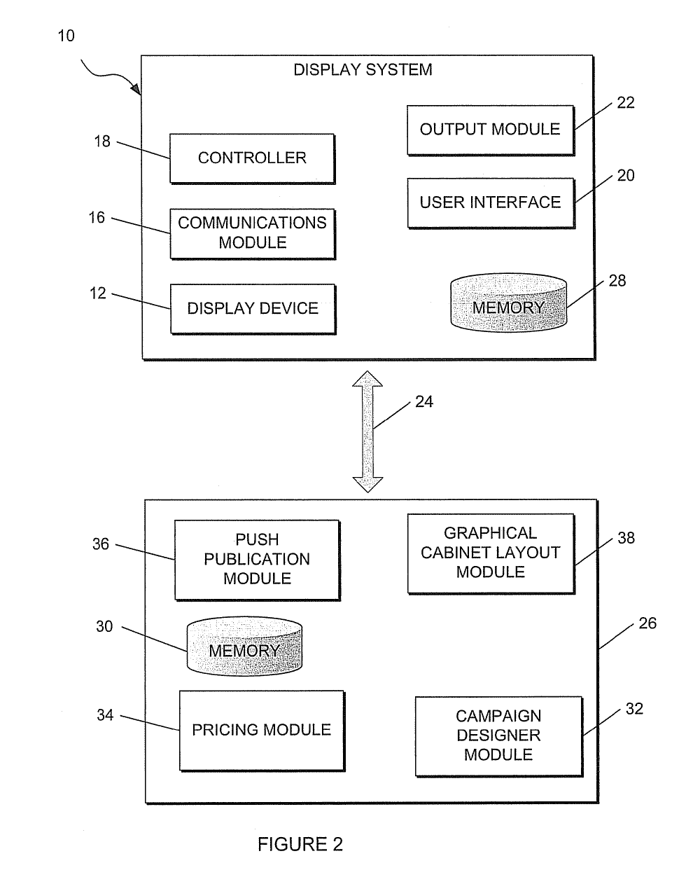

Referring to FIGS. 1 and 2, a display system 10 for products and/or services for rent or sale is illustrated.

In one embodiment of the invention, the system 10 includes a plurality of display devices 12 for displaying information relating to at least one product and/or service.

In one example each of the plurality of display devices 12 is associated with a product and/or service for rent or sale so that information pertaining to the associated product and/or service is displayed on the display device.

In the illustrated embodiment, the product is shown as a cellphone 14. It will be appreciated that this could be any product and/or service.

Thus, in this example, each cellphone will have a separate display device 12 associated with it and typically located adjacent it so that information pertaining to that particular cellphone can be displayed on the display device 12 associated with it.

A communication module 16 (shown in FIG. 2) is used for receiving information relating to the at least one product 14.

A controller 18 is connected to the communication module 16 and to the plurality of display devices 12.

The controller 18 controls the display of the information on at least one of the plurality of display devices 12.

The system further includes a user interface 20 for receiving a product and/or service selection from a user.

In the illustrated embodiment, the user interface 20 is incorporated into the plurality of display devices 12 at least some of which include a touch screen by way of which a user can select various options presented to them via the display.

It will be appreciated that the user interface 20 could take any other suitable form.

An output module 22 is used to output a user's selection.

In the illustrated embodiment, displayed to the user via a display device 12 will be an option to purchase the product and/or service.

If the user selects this option, the controller 18 instructs the output module to output the user selection.

In the illustrated embodiment, the output module 22 is a printer that prints the user selection.

The output module may also be any form of communication to user in the form of digital content whether it is email, SMS or file.

The user then takes the printed paper with the barcode thereon to a cashier at a point of sale who will obtain the product and/or service for the user and receive payment from the user.

In another example embodiment, at least one of the display devices 12a is larger than the others. At least one of the other display devices 12 informs the user that information pertaining to the associated product and/or service displayed on the display device can be viewed on the larger display device 12a on receipt of a user input.

When the controller 18 receives this user input via the user interface, the controller controls the display of the requested information on the larger display device.

The information displayed on the larger display device 12a could be the same information that is displayed on the smaller display device 12 but will typically be more comprehensive information better viewed on a larger screen.

One example of where this might be used is where the products on display are gaming, software and DVD titles. The smaller display devices 12 may include some information about the title with which it is associated and may include an option of receiving more information on the larger screen 12a. Typically, this will be in the form of a trailer, demo or preview of audiovisual content.

In one embodiment, the communication module 16 receives information to be displayed in a layered format wherein one or more of the layers may be updated without affecting the other layers thus enabling some information pertaining to a product and/or service to be changed without altering the remaining information.

In this regard, the communication module 16 communicates via a communications network 24 with an external server 26.

It will be appreciated that this network 24 could be any suitable network including, for example, a GSM network.

The external server 26 sends content to the display system 10.

In one example embodiment, the server 26 is accessible via the Internet or private network both to the managers of the server 26 and also, for example, to the owners of stores wishing to manage or updated their content.

Thus, in one example embodiment the owner of a particular chain of stores logs into the server 26 and updates information that for a certain area and a period of time a particular product of service will cost less.

As described above, only the layer containing the particular information will be altered and transmitted via the communications network 24 to the communication module 16.

The information will be stored in a memory 28 and accessed by the controller 16 which will update the information being displayed on the display device 12.

Because only the particular layer of information is altered, it will be appreciated that less data needs to be transmitted to the display system and updated in the memory 28 thus providing a faster and more flexible system.

In addition to the above, the system allows various users to be setup individually under their own profile, branding, security restrictions, authentication flow etc. This means that the user can design, maintain, manage and publish their own campaigns without affecting other users.

The system also allows suppliers to provide global product information to the system which allows users to use this information in their own campaigns with the option to brand and modify it according to their needs.

The system includes a campaign designer module 32 typically located on the server 26 that allows the client to create their own designs, campaigns and templates from any web browser. The media is stored remotely on a memory associated with the server 30 and can be used on campaigns or pages as needed.

The campaign designer module also supports timers, actions, hyperlinks, images, flash content and video's based on the client rotation settings with various screen size and resolution options ranging from 3.5″, 7″ and ultimately any size and rotation screen.

As mentioned above, the campaign designer is used to design and modify campaigns. It includes the following components and layers:

Page Administration: Campaigns can contain unlimited pages. Each page contains a collection of media content and interactive components. Page Administration allows one to create new pages or edit existing pages for each campaign;

Hotspot Action Layer: This tool allows one to define the interactive parts of a page. One can place hotspots over any other media objects, including text, pictures, videos, prices and other customised layers. Several different actions can be assigned to an interactive component, actions can also be layered to create multifunction actions on individual pages, including the following standard actions (custom actions can be integrated to perform specific tailored actions);

Jump to Page: This action acts link a hyperlink between multipage campaigns.

Print: This action sends a message to the printer (more information provided later in documentation);

Remote Command: This action sends a customized command to another device within the specified cabinet. This action either interfaces with a single IP address to send the message to, or broadcast it to all devices within current the cabinet (cabinets typically consists of grouped devices). The following command are available:
Jump Page: This changes the page on a remote device. This is often used, for example, for starting a video on different screen connected to another device. The remote device typically has a campaign with a video page, and the video can be toggled remotely;
Switch Slot: Devices can contain more than one campaign concurrently. Each one of these campaigns exists in a slot. This command allows one to change the campaign running on another device in the same cabinet. This is useful for switching the look and feel of all the campaigns on the cabinet simultaneously;
Background layer: This tool allows one to select a background image for the current page. A background is tiled across the screen;
Image layer: This tool allows one to add an layered image onto a page. It can be in any of the popular image formats; jpg, png, gif, bmp;
Video layer: This tool allows one to add a video to the page. Several options can be chosen when adding a video. It can be set to always run full screen, and to repeat automatically. One can also attach actions to videos. For example, when the video completes, Jump to a different page. Any of the actions already discussed in the hotspot section can be attached to a video;
Text layer: This tool allows one to add any text to a campaign. True Type font are fully supported. Advanced font encoding systems allows the Campaign Designer to display the text exactly as it will appear on the device, and embeds the font within the campaign downloaded to the device. One can change the size and colour of the text;
Timer Trigger: This tool does not have a physical appearance in the campaign. It allows one to add actions that will be triggered automatically after a given interval. It is often used to page campaigns automatically when there is no interaction. Any of the actions already discussed in the Hotspots section can be triggered by a timer;
Thermal printing capability: This allows one to design printing slips in the browser. A Printing slip is a customised PDF document that is sent to a thermal printer within the cabinet. The printing slip designer allows one to:
   Select a price that will appear on a printing slip, when multi pricing layers are involved;
   Add a barcode to the slip: This barcode is automatically generated from a given product code;
   Add an image to the slip;
   Add a list of features;
   Add a footer;
   Add a title;
   The platform supports multiple printing slips in the same campaign, and the printing slip can be selected when adding the print action to a page;
Page and Campaign rename function: this function allows one to rename page and campaign title without over writing record ID's;
Price administration function: This allows one to change the prices of a campaign;
Product type selection: Each campaign can be grouped to a certain Product Type and model information. This is used to determine the slot on the device locking the device down to only display a certain campaign and/or information. This function makes part of information gathering for reporting purposes;
Media Manager and File Management

The media manager allows for uploading, view and administration of the media content that will be used in campaign creation. Multiple multimedia files can be uploaded at the same time, and can be ‘tagged’ for easy retrieval later. Any of the following can be uploaded:
Images (PNG/BMP/JPG/GIF);
Video (AVI/MPEG4/MPG);
Fonts (TTF);
Flash;
Executable files;
Layered actions;

Printing, email, sms, any form of output communication can also be added as an action to any page which allows the end-user to receive the necessary information of the product they are interested in either for future reference and comparisons or for high-end products. This information may contain a barcode which can be presented at the till through the POS system as described above.

The server 26 also includes a pricing module 34 that contains a multi pricing structure which allows the user to manage, update and publish pricing remotely. It also allows the user to do bulk price updates through the use of Excel Spread sheets or flat files. Once the pricing has been updated it will be pushed to the digital devices 10 without updating or affecting the whole campaign.

The pricing is implemented by a highly specialised version of the text tool. It allows one to place a pricing layer and/or multiple pricing layer on a page/s in the campaign that can later be updated by selecting the campaign pricing without having to change the campaign itself. For example, one can download a list of all the prices, change them, and upload the price list again. All devices will then automatically display the new prices.

Various prices can be added to one page of a template, design or campaign. This means that the client can have multi-pricing structures on one page such as individual pricing, contract pricing, bulk pricing etc.

A remote push publication module 36 allows a user to push new campaigns, designs, templates and pricing to any device, multiple devices or cabinets in the field at any given time.

Display devices 12 can also be added to cabinets therefore when a new price or information has been released it will update all systems that are owned by the user nationwide or based on a specific retailer depending or a specific device 12 on the users' configuration.

A graphical cabinet layout module 38 allows a preview of the information which allows a user to easily manage and relocate information, reboot systems, manage devices 12 on a cabinet.

This also allows the user to send commands to the remote systems anytime and everywhere when required during setup or when the device needs to be maintained or upgraded remotely. Typically, this will include a remote hard reboot be form of cutting power to device 12 or suspending the device 12 in administrative mode ready for user maintenance from the device 12 input.

A dashboard system allows for viewing of the current state of the system/network to a single screen, and is updated on a continuous basis. This is achieved with a heartbeat poll every few seconds. It currently includes the following views and more:
The health of the all devices;
The health of the all Cluster/s;
The health of the network;
The amount of devices online;
A list of recent campaigns;
A list of the most popular campaigns;
General system information;

The dashboard is fully customisable, so users can hide irrelevant information and only show the views which are important to them.

The reporting system also makes it possible to generate various reports on all consumer interaction on the system with a click of a button. These reports can be viewed online or be exported to various formats including PDF, Excel or Word.

Reporting parameters can be filtered by date, time, users, service, enquiry type, location, interaction, content delivery, uptime, consumer detail, viewing a breakdown of the most popular campaigns and even the most popular pages. All reports are designed to enable trend analysis and comparisons of information between branches and across time periods from a central server with no need to collate information from individual offices to provide corporate performance information.

Every page selection on a device 12 is recorded and transmitted back to the server 26 where it is stored in database 30. Therefore users can determine through the use of reports which products are the most popular and in which regions, retailers and cabinets and how many clicks they receive per hour, day or month.

It will be appreciated that the modules described above may be implemented in hardware and/or software and/or both.

In one example, the modules are on a machine-readable medium embodying instructions which, when executed by a machine, cause the machine to perform any of the methods described herein.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

1. A display system for products and/or services for rent or sale, the system including:
a plurality of display devices for displaying information relating to at least one product and/or service;
a communication module for receiving information relating to the at least one product and/or service for use in the display system;
a controller for controlling the display of the information on at least one of the plurality of display devices;

2. A system according to claim 1 wherein the system further includes:
a user interface for receiving a product and/or service selection from a user; and
an output module to output the user's selection.

3. A system according to claim 2 wherein the output module is a printer that prints the user selection.

4. A system according to claim 3 wherein the user selection prints the user selection in the form of a barcode.

5. A system according to claim 1 wherein each of the plurality of display devices is associated with a product and/or service for rent or sale so that information pertaining to the associated product and/or service is displayed on the display device.

6. A system according to claim 1 wherein at least one of the display devices is larger than the others and at least one of the other display devices displays to the user that information pertaining to the associated product and/or service displayed on the display device can be viewed on the larger display device on receipt of a user input, wherein the controller, on receipt of the user input, displays the requested information on the larger display device.

7. A system according to claim 1 wherein the communication module may receive information to be displayed in a layered format wherein one or more of the layers may be updated without affecting the other layers thus enabling some information pertaining to a product and/or service to be changed without altering the remaining information.
